(19) United States
(12) Patent Application Publication
(10) Pub. No.: US 2024/0140665 A1
(43) Pub. Date: May 2, 2024

(54) SCAVENGING OXYGEN

(71) Applicant: COLORMATRIX HOLDINGS, INC., Avon Lake, OH (US)

(72) Inventors: MARK RULE, Avon Lake, OH (US); Heather BURIK, Avon Lake, OH (US); Alan BARCON, Avon Lake, OH (US); Andrew ELKIN, Merseyside (GB); Adrian CHRMICHAEL, Merseyside (GB); Steve Burgess TATTUM, Merseyside (GB)

(21) Appl. No.: 18/269,007

(22) PCT Filed: Dec. 17, 2021
(86) PCT No.: PCT/IB2021/061945

§ 371 Date: Jun. 22, 2023

Related U.S. Application Data
(60) Provisional application No. 63/129,763, filed on Dec. 23, 2020.

(51) Int. Cl. B65D 51/24; C01B 3/04

(52) U.S. Cl. CPC B65D 51/244; C01B 3/042; C01B 2203/0277

(57) ABSTRACT

A container comprises: (i) a hydrogen generating means comprising an active material arranged to generate molecular hydrogen on reaction with moisture; (ii) a catalyst capable of catalyzing a reaction between molecular hydrogen and molecular oxygen; and (iii) a barrier means for restricting passage of small organic molecules from a product contained, in use, in the container, to the catalyst associated with a closure or body wall of the container.

### BACKGROUND

This invention relates to the scavenging of oxygen and particularly, although not exclusively, relates to the scavenging of oxygen in containers, for example food or beverage containers.

Polymers such as poly(ethylene terephthalate) (PET) are versatile materials that enjoy widespread use for fibres, films and three-dimensional structures. A particularly important application for polymers is for containers, especially for food and beverages. This application has seen enormous growth and continues to enjoy increasing popularity. Despite this growth, polymers have some fundamental limitations that restrict their applicability. One such limitation is that all polymers exhibit some degree of permeability to oxygen. The ability of oxygen to permeate through polymers such as PET into the interior of the container is a significant issue, particularly for foods and beverages that are degraded by the presence of even small amounts of oxygen. For the purpose of this disclosure, permeable means diffusion of small molecules through a polymeric matrix by migrating past individual polymer chains, and is distinct from leakage, which is transport through macroscopic or microscopic holes in a container structure.

To address the aforementioned problem, products may be packaged in plastic packages which incorporate passive barriers to oxygen and/or oxygen scavengers. Generally, greater success has been achieved utilizing oxygen scavengers; however, oxygen scavenging materials heretofore have suffered from a number of issues. Some oxygen scavengers utilized to date rely on the incorporation of an oxidizable solid material into the package. Technologies utilized include oxidation of iron (incorporated either in sachets or in the container sidewall), oxidation of sodium bisulfite, or oxidation of an oxidizable polymer (particularly poly(butadiene) or m-xylylenediamine adipamide). All of these technologies suffer from slow rates of reaction, limited capacity, limited ability to trigger the scavenging reaction at the time of filling the container, haze formation in the package sidewall, and/or discoloration of the packaging material. These problems have limited the use of oxygen scavengers in general, and are especially significant for transparent plastic packaging (such as PET) and/or where recycling of the plastic is considered important.

Applicant's publication number WO2008/090354A1 discloses a container comprising an active substance which is incorporated in the container and is arranged to react with moisture in the container to release molecular hydrogen. The document describes a wide range of potential active substances including metals and/or hydrides, with sodium borohydride being exemplified as the active material which is arranged to generate hydrogen by reaction with water. The hydrogen released reacts, in the presence of a Group VIII metal, preferably palladium or platinum, catalyst in the closure or bottle wall with ingressing oxygen in the container, to produce water.

WO2010116192 addresses a problem associated with use of sodium borohydride described in WO2008090354A, in that sodium borohydride can react with aldehydes which are important flavour components of foods and beverages. An increased loss of these flavour components by reaction with the active substance may have a detrimental effect on the flavour of the food or beverage—i.e. the flavour is scalped and such scalping may get worse over time. To address this problem, WO2010116192 proposes use of calcium hydride. However, even when using calcium hydride, it cannot be ruled out that reaction of flavour components will not produce “non-intentionally-added-substances” (NIAS).

Even though calcium hydride is a non-reducing hydride, it has been found that, when catalyst is in the vicinity of hydrogen being generated, flavour molecules may migrate and be catalytically reduced, with a risk that NIAS may be produced. For example, if a packaged food or beverage contains benzaldehyde then, in the presence of hydrogen and catalyst, there is a possibility the benzaldehyde could react to produce benzyl alcohol which may theoretically further react to produce toluene. If this happened, toluene would be an undesirable NIAS. Preferred embodiments of the present invention have, as one object, the mitigation of any perceived risk of production of NIAS by catalytic reaction of components in a contained food or beverage.

In addition to the aforesaid, Applicant has previously described how, when palladium catalyst is distributed in the wall of a PET container for catalysing the reaction of hydrogen and oxygen, for example as described in WO 2008/090354A1, there is a risk the catalyst may be poisoned by constituents of the resin. This problem may be particularly acute for PET resins made using an antimony-based catalyst, since the antimony tends to poison the palladium catalyst. This problem has made it difficult to exploit the oxygen scavenging invention described in WO 2008/090354A1 using containers comprising PET resins made using an antimony-based catalyst. It is an object of preferred embodiments of the present invention to address the aforesaid problem.

Thus, it is an object of preferred embodiments of the present invention to address the above described problems.

### SUMMARY OF INVENTION

According to a first aspect of the invention, there is provided a closure for a container, the closure comprising:
(i) a hydrogen-generating means comprising an active material arranged to generate molecular hydrogen on reaction with moisture;
(ii) a catalyst capable of catalyzing a reaction between molecular hydrogen and molecular oxygen;
(iii) a barrier means for restricting passage of organic molecules to the catalyst;
   wherein said closure has a toluene production value (TPV) of less than 0.00800 mg, preferably less than 0.00750 mg after 24 hours; and/or wherein said closure has a toluene production value (TPV) of less than 0.04000 mg, preferably less than 0.03000 mg, more preferably less than 0.02000 mg, after 72 hours.

According to a second aspect of the invention, there is provided a container comprising:
(i) a hydrogen generating means comprising an active material arranged to generate molecular hydrogen on reaction with moisture;
(ii) a catalyst capable of catalyzing a reaction between molecular hydrogen and molecular oxygen;
(iii) a barrier means for restricting passage of organic molecules from a product contained, in use, in the container, to the catalyst.

### DETAILED DESCRIPTION

Unless otherwise stated, a reference to “ppm” herein refers to “parts per million” by weight.

For purposes of this disclosure, a container suitably includes any package that surrounds a product and that contains no intentional microscopic or macroscopic holes that provide for transport of small molecules between the interior and the exterior of the package.

In the first aspect, the TPV may be the amount of toluene in mg calculated as described when the closure is subjected to the following process:
(i) A region of the closure containing catalyst is fully covered with a calculated quantity of benzaldehyde solution (comprising 300 ppm of benzaldehyde in deionized water). The calculated quantity is such that the volume of benzaldehyde solution used is 2.0 ml of benzaldehyde solution per square centimetre of a surface area of the region of the closure containing catalyst which has the greatest surface area. When the closure is of the type generally shown in FIGS. 4 to 8, benzaldehyde solution may be introduced into an inverted closure as shown in FIG. 8. The surface area of that closure is the surface area of the exposed face of test material 70 (which includes catalyst). If more than one layer includes catalyst the surface area is that of the layer with the greatest surface area.

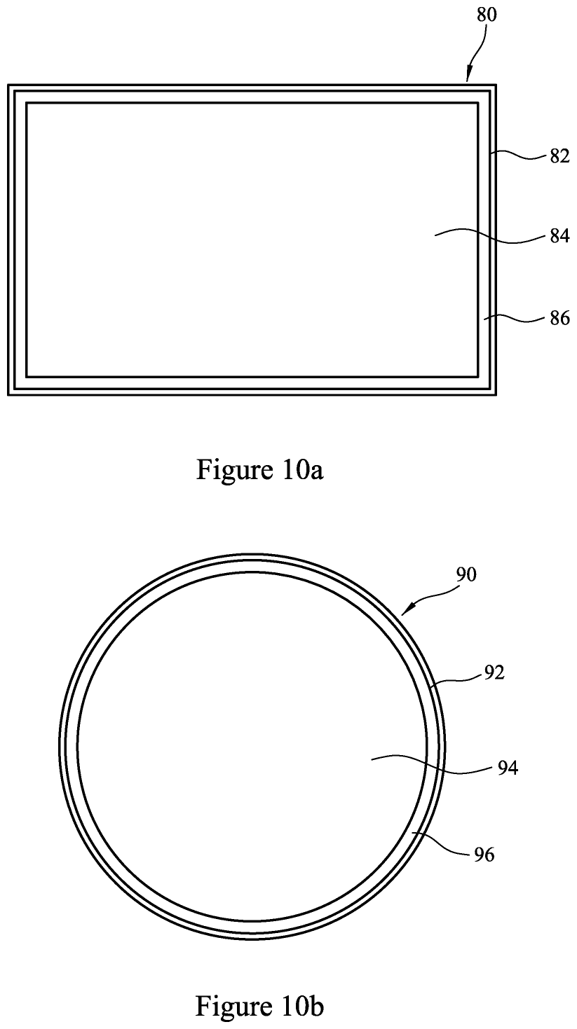

When the closure does not include a closure shell and may for example comprise a film and/or laminate, the film and/or laminate in a substantially flat state is fully immersed in said benzaldehyde solution in a container, wherein the cross-sectional area of the container in which the film and/or laminate is positioned is only slightly greater (eg no more than 10% greater area) than the cross-sectional area of the film and/or laminate. For example, such a film and/or laminate may be positioned as shown in FIGS. 10a and 10b. Referring to FIG. 10a, container 80 has a wall 82 and film and/or laminate 84 is positioned in the container with only a small gap 86 being defined between the wall 82 and film and/or laminate 84. Similarly, referring to FIG. 10b, container 90 has a wall 92 and film and/or laminate 94 is positioned in the container with only a small gap 96 being defined between the wall 92 and film and/or laminate 94.
(ii) In all cases, a closure should be arranged in a sealed glass container (e.g. glass jar) of sufficient size to contain the closure as aforesaid, but no larger than 12 times the volume of benzaldehyde solution added in step (i) for 24 hours.
(iii) Immediately after 24 hours, the sealed glass container is opened and 60% of the volume added in step (i) is removed as a test sample.
(iv) The concentration of toluene in the test sample comprising benzaldehyde solution removed in step (iii) is measured and recorded in mg/ml. This may be undertaken using any quantitative analytical measurement which is capable of measuring toluene in an aqueous solution to less than 1 ppb.
(v) The value measured in step (iv) is multiplied by the volume (in litres) of benzaldehyde solution referred to in step (i) to calculate the TPV. Results are reported in mg.

Steps (i) to (iv) are undertaken at ambient temperature which may be fixed at 20° C.

Steps (i) to (v) may be repeated, except that step (iii) is extended to 72 hours to calculate TPV after that time.

The TPV per unit area (herein the “TPV-UA”) of said closure may be less 0.00200 mg/cm² (preferably less than 0.00150 mg/cm², after 24 hours; and/or the TPV per unit area of said closure may be less than 0.01000 mg/cm² (preferably less than 0.00500 mg/cm², more preferably less than 0.0045 mg/cm²) mg/cm² after 72 hours, wherein:

$$TPV - UA = \frac{TPV in mg}{\begin{matrix}the surface area ( in {cm}^{2} ) of a catalyst - \\ containing layer of the closure which has the greatest surface area .\end{matrix}}$$

The following statements apply to the first and/or second aspects.

Said barrier means is suitably positioned between a position in said container wherein product is contained in normal use and said catalyst. Preferably, the barrier means is arranged so that there is substantially no path for passage of a component of a product contained in use in said container to the catalyst except via said barrier means.

Preferably, substantially the entirety of said catalyst is shielded from product and/or components thereof contained in use in said container by said barrier means, preferably so there is substantially no path unimpeded by said barrier means for passage of product and/or components thereof to said catalyst.

Preferably, the distance between catalyst and barrier means is less than 10 mm, less than 5 mm or less than 1 mm. In some case, the catalyst and barrier means abut so the distance may be zero mm.

Preferably, at least 80 wt %, more preferably at least 95 wt %, especially at least 99 wt % of said catalyst in said container is within a linear distance of less than 10 mm or less than 5 mm or less than 2 mm of said barrier means.

Preferably, said barrier means comprises:
(AA) a barrier material which has a Hildebrand Solubility Parameter (HSP) of less than 16.0 MPa^{1/2}; and/or
(BB) a barrier material which is a porous material, for example a microporous material which suitably includes pores with free diameters of less than 2 nm; and/or
(CC) a barrier material which surrounds individual particles of catalyst so that a mass of composite particles is defined, wherein each of said composite particles comprises catalyst surrounded by said barrier material.

Preferably, said barrier means is arranged to restrict passage of organic molecules as described based on physical properties, for example of organic molecules relative to the barrier means. Benzaldehyde may be used as a reference material for organic molecules as descried herein, in which case, said barrier means is suitably arranged to restrict passage of benzaldehyde molecules.

Said barrier means is preferably arranged to restrict passage of organic molecules, for example, benzaldehyde, on the basis of a physical property of said barrier means. Said physical property may be based on size or may be based on polarity of the barrier means.

When the function of said barrier means to restrict organic molecules, for example benzaldehyde, is based on size, said barrier means may be porous with the pore size being such as to restrict, for example, exclude organic molecules, for example benzaldehyde; but, preferably, the pore size is such as to allow passage of other desired molecules, for example oxygen, hydrogen and water as described herein.

When the function of said barrier means to restrict organic molecules, for example benzaldehyde, is based on polarity, said barrier means may have a sufficiently different polarity compared to the polarity of organic molecules, especially benzaldehyde (suitably used as a reference, irrespective of whether a product contained, in use, in the container includes benzaldehyde).

When said barrier means is as described in (AA), said barrier means may restrict passage of organic molecules, especially benzaldehyde, due to the difference in the HSP of the barrier means compared to benzaldehyde which has a HSP of 19.2 MPa^{1/2}. Preferably, the difference between the HSP of benzaldehyde and a barrier material of said barrier means is at least 3.2 MPa^{1/2}, preferably at least 4.0 MPa^{1/2}. Said difference may be less than 10 MPa^{1/2} or less than 7.0 MPa^{1/2}.

Said barrier material of said barrier means may have a HSP of less than 16.0 MPa^{1/2}, preferably less than 15.8 MPa^{1/2}, more preferably less than 15.6 MPa^{1/2} and, especially, less than 15.2 Mpa^{1/2}. In some cases, said HSP may be less than 14.0 MPa^{1/2} or less than 13.2 MPa^{1/2}. Said barrier material may have a HSP of at least 5.0 MPa^{1/2}, preferably, at least 8.0 MPa^{1/2}, more preferably at least 10.0 MPa^{1/2}.

Said barrier means may comprise a layer of said barrier material. Said layer is preferably substantially continuous. Said layer suitably has a thickness of less than 1 mm, preferably less than 0.5 mm. In some case, for example wherein a barrier material surrounds individual particles of catalyst so that a mass of composite particles is defined, said layer may be less than 0.1 mm or preferably less than 0.01 mm. Said layer preferably has a thickness which varies by less than 1mm across its extent. Preferably, the ratio of the maximum thickness of said layer divided by the minimum thickness of said layer is less than 2.0. Said layer preferably has a substantially constant thickness across its extent.

In an embodiment (A1), said layer may be in a lamina form. For example, said layer may not be endless. It may have at least one end. It may have at least one edge. The end or edge is suitably an outer surface of the layer (e.g. which defines the thickness of the layer), wherein the end or edge extends transverse to, for example perpendicular to, a main area of the layer, wherein the main area of the layer is suitably defined by a surface of the layer which has the greatest area. Said main area may have an area of at least 2 cm² or at least 3.5 cm². Said layer may have first and second spaced apart ends.

A said layer in accordance with embodiment (A1) may be arranged as a layer in a closure of the container or may be a layer of a container body of said container. Said layer may comprise a fluorinated polymer as described in Example 17 et seq.

In an embodiment (A2), said layer may define a coating, for example, an enclosure, suitably on and/or around catalyst for example catalyst particles. Said layer may be endless. It may be continuous. It may fully enclose catalyst. Said layer may have a thickness of no greater than 0.01 mm, preferably across substantially its entire extent. Said layer may define a barrier material which surrounds individual particles of catalyst so that a mass of composite particles is defined, each of which composite particles comprises catalyst surrounded by said barrier material. Said layer may comprise a fluorinated polymer as described in Example 23; or may comprise a silicone-based material, for example one made using a platinum catalyst such as a dimethicone polymer, manufactured using a platinum catalyst in a hydrosilylation reaction.

When said barrier means is as described in (BB), said porous material is suitably selected to restrict passage of organic molecules, especially benzaldehyde, on the basis of the size of pores in the porous material relative to the size of organic molecules, especially benzaldehyde (suitably used as a reference compound). Preferably, said porous material is selected to allow and/or not substantially act as a barrier to hydrogen, oxygen and water molecules. Thus, said barrier means may restrict passage of organic molecules, especially benzaldehyde, to the catalyst associated with the barrier means, whilst allowing passage of hydrogen and oxygen to catalyst and water away from the catalyst.

Said catalyst is preferably embedded in the porous material, for example in a pore structure thereof. Said porous material is suitably microporous and suitably includes pores with free diameters of less than 2 nm. The pores may have free diameters of at least 0.4 nm.

Said porous material is preferably inorganic.

Said porous material preferably has a zeolithic structure.

Said porous material may have a relatively hydrophilic internal environment. Said porous material may comprise a zeolite with a Si/Al ratio of less than 2. Said porous material may comprise, preferably consists essentially of, a zeolite which may be selected from NaX, CaX or CaA zeolites.

Said porous material preferably includes at least 0.05 wt %, for example at least 0.15 wt % of catalyst. The amount of catalyst in said porous material may be less than 1.00 wt % or less than 0.50 wt %.

When said barrier means is as described in (CC), said barrier material of said barrier means may restrict passage of organic molecules, especially benzaldehyde, due to a physical property of the barrier means wherein, suitably, the physical property is based on size or polarity differences between molecules it is desired to allow to pass through the barrier material and organic molecules (especially benzaldehyde), the passage of which through the barrier material is to be restricted. Said barrier material may have a HSP as described in (AA) or may have porosity, for example as described with reference to the barrier material described in (BB).

Said barrier material (and suitably associated catalyst) may be associated with a polymeric material (XX). Polymeric material (XX) is preferably not the same as any polymeric material which may be a component of said barrier material and/or said barrier means. When said barrier material has a HSP of less than 16.0 MPa^{1/2}, said polymeric material (XX) preferably has a HSP which is higher than the HSP of the barrier material and/or is greater than 16.0 MPa^{1/2}, preferably greater than 16.1 MPa^{1/2}, more preferably greater than 16.5 MPa^{1/2}. The difference between the HSP of polymeric material (XX) and the HSP of the barrier material may be at least 0.5 MPa^{1/2}, preferably at least 1.0 MPa^{1/2}, more preferably at least 1.5 MPa^{1/2}.

Said polymeric material (XX) may have a HSP in the range 16.1 to 30.0 MPa^{1/2}. Said polymeric material (XX) preferably defines a layer, for example, of a closure.

Said barrier material may be associated with said polymeric material (XX) in a number of different ways. In an embodiment (B1), said barrier material may be distributed, for example, dispersed, within polymeric material (XX). In this case, a combination comprising said barrier material and associated catalyst may be dispersed in said polymeric material (XX).

In an example (B1-i), the barrier means may be as described in (AA), for example as described in embodiment (A2), and may comprise a layer of said barrier material and said layer may define a coating, for example, an enclosure, suitably around catalyst, for example catalyst particles. The aforementioned combination of barrier material and catalyst may be distributed, for example dispersed within polymeric material (XX).

In an example (B1-ii), the barrier means may be as described in (BB) and porous material and associated catalyst may be distributed, for example dispersed within, polymeric material (XX). Preferably, as described with reference to (BB), the catalyst is embedded in the pore structure of the porous material which suitably has a zeolithic structure. The combination of catalyst and porous material is preferably dispersed in polymeric material (XX).

In an alternative embodiment (B2) wherein barrier material and said polymeric material (XX) are associated, said barrier material may overlie the polymeric material (XX) and may contact, for example make face-to-face contact with, said polymeric material (XX). In some cases, said barrier material and said polymeric material (XX) may define distinct and/or separable layers. For example, said barrier material may be as described in (AA) and said polymeric material (XX) may be different to said barrier material. In another case, for example wherein said barrier means and/or barrier material is defined by functionalising (e.g. fluorinating) a surface region of a polymeric material (XX) (e.g. as described in Example 17 hereafter), there may be no distinct layer of barrier material which can be separated from polymeric material (XX).

In embodiment (B2), catalyst may be dispersed in one or both of said barrier material and polymeric material (XX). It is suitably dispersed in both materials.

Polymeric material (XX) may be selected from HDPE, PP, LLDPE, LDPE, PS, PET, EVA, SEBS, Nylon (e.g. Nylon-6), thermoplastic elastomers (TPEs) and olefinic block copolymers (OBCs) and mixes of these and other polymers. Polymeric material (XX) is preferably a polyolefin polymer for example a polyethylene.

In a preferred embodiment, said barrier material does not comprise HDPE, PP, LLDPE, LDPE, PS, PET, EVA, SEBS, Nylon (e.g. Nylon-6), thermoplastic elastomers (TPEs) or olefinic block copolymers (OBCs).

Said catalyst may be associated with a closure of the container and/or may be associated with a container body of the container. Preferably, said container comprises a closure and a container body. The container body suitably defines a volume in which a product is contained, in use, in the container; and said closure cooperates with the container body to close and/or seal the container. In some cases, said closure may be releasably securable to the container body in which case, suitably, the closure and container body are screw-thread to allow screw-threaded engagement of the closure to the container body. Alternatively, said closure may not be releasable securable and/or may be a single use closure such as may be defined by a film closure which is adhered to the container body. Such a film closure may be associated with a tray or may comprise a foil liner which is arranged to close a bottle, such as a ketchup bottle or the like.

The shape, construction, or application of the containers described is not critical. In general, there is no limit to the size or shape of a container. For example, the container may be smaller than 1 milliliter or greater than 1000 liter capacity. The container preferably has a volume in the range 20 ml to 100 liter, more preferably 100 ml to 5 liter or 100 ml to 2 liter. A container may be selected from a sachet, bottle, jar, bag, pouch, tray, pail, tub, barrel or blister pack. Preferably, said container is a bottle or tray.

Said catalyst is selected to catalyse the reaction between molecular hydrogen and molecular oxygen, to produce water. A large number of catalysts are known to catalyze the reaction of hydrogen with oxygen, including many transition metals, metal borides (such as nickel boride), metal carbides (such as titanium carbide), metal nitrides (such as titanium nitride), and transition metal salts and complexes. Of these, Group VIII metals are particularly efficacious. Of the Group VIII metals, palladium and platinum are especially preferred because of their low toxicity and extreme efficiency in catalyzing the conversion of hydrogen and oxygen to water with little or no by-product formation. The catalyst is preferably a redox catalyst.

Unless otherwise stated, the amounts (e.g. ppm, wt %, etc.) of catalyst referred to herein are the amounts of active species, for example metal, which are able to catalyse the reaction between molecular hydrogen and molecular oxygen, excluding any coordinated groups. Thus, when palladium acetate is used to deliver palladium, the ppm, wt %, etc. referred to herein refer to the ppm or wt % etc., of palladium delivered, excluding the acetate moieties.

Said catalyst is preferably a metal, preferably a transition metal, preferably selected from Group VIII metals, for example palladium and platinum.

Suitably, references to catalyst for catalysing a reaction between hydrogen and oxygen refer to all such catalysts, even if different types of such catalyst are included in said container. However, preferably said container includes a single type of catalyst.

A reference to “ppm” herein refers to “parts per million” by weight.

Said hydrogen generating means suitably includes a matrix material with which said active material is associated. In this case, the ratio of the weight of active material to matrix material may be at least 0.01, preferably at least 0.02. Preferably, the matrix comprises a polymeric matrix and said active material is dispersed therein. In general, once an active material is dispersed into a polymer, the rate of release of hydrogen is limited by the permeation rate of water into the polymeric matrix and/or by the solubility of water in the chosen matrix. Thus, selection of polymeric materials based on the permeability or solubility of water in the polymer allows one to control the rate of release of molecular hydrogen from active materials. However, by selection of appropriate control means, the rate determining step for release of hydrogen may be determined by properties of said control means, as described herein.

The matrix may include at least 1 wt % of active material, preferably at least 2 wt %. The matrix may include less than 70 wt % of active material. Suitably, the matrix includes 1-60 wt %, preferably 2-40 wt % of active material, more preferably 4-30 wt % of active material. The balance of material in the matrix may predominantly comprise a said polymeric material. It may include other additives, for example fillers (e.g. oils) and materials to make the appearance of the matrix appear more visually uniform.

Said active material may comprise a metal and/or a hydride. A said metal may be selected from sodium, lithium, potassium, magnesium, zinc or aluminum. A hydride may be inorganic, for example it may comprise a metal hydride or borohydride; or it may be organic.

Active materials suitable for the release of molecular hydrogen as a result of contact with water include but are not limited to: sodium metal, lithium metal, potassium metal, calcium metal, sodium hydride, lithium hydride, potassium hydride, calcium hydride, magnesium hydride, sodium borohydride, and lithium borohydride. While in a free state, all of these substances react very rapidly with water; however, once embedded into a polymeric matrix, the rate of reaction proceeds with a half-life measured in weeks to months, for example when stored at ambient temperature.

Selection of suitable active substances for incorporation into a polymeric matrix can be based on a number of criteria, including but not limited to cost per kilogram, grams of H₂ generated per gram of active substance, thermal and oxidative stability of the active substance, perceived toxicity of the material and its reaction byproducts, and ease of handling prior to incorporation into a polymeric matrix. Of the suitable active substances, hydrides are preferred; sodium borohydride is exemplary because it is commercially available, thermally stable, of relatively low cost, has a low equivalent molecular weight, and produces innocuous byproducts (sodium metaborate).

Calcium hydride is the most preferred active substance. Preferably, said hydrogen generating means comprises calcium hydride. Preferably, said hydrogen generating means comprises calcium hydride dispersed in said polymeric matrix. Preferably, the polymeric matrix includes at least 10 wt % or at least 20 wt % of calcium hydride. Said polymeric matrix preferably includes 10 to 35 wt %, more preferably 18 to 28 wt % of calcium hydride; and preferably includes 65 to 90 wt %, more preferably 72 to 82 wt %, of said polymeric matrix. A preferred polymeric matrix is a polyolefin, with polyethylene being especially preferred.

Preferably, a closure of said container includes said hydrogen generating means.

Said container preferably includes a control means for controlling the passage of moisture, for example water or water vapour (e.g. from a product contained in the container) to said active material arranged to generate molecular hydrogen. Providing a control means as described introduces substantial flexibility which allows control of the rate of production of hydrogen by the hydrogen generating means and tailoring of the time over which hydrogen is generated, which determines the shelf-life of the container. For example, to achieve a long shelf-life a relatively large amount of active material may be associated with a matrix and by controlling passage of moisture to the hydrogen generating means, the rate of hydrogen generation is controlled as is the rate of consumption of the active material. In contrast, in the absence of the control means, the relatively large amount of active material would produce hydrogen at a quicker rate and would be consumed quicker meaning the shelf-life of the container would be less.

Said control means is preferably arranged to control a first evolution ratio, wherein the first evolution ratio is defined as:

$$\frac{the rate of evolution of hydrogen in the container over a selected initial 5 day period}{\begin{matrix}the rate of evolution of hydrogen in the container over a second 5 day period starting \\ 85 days after the end of the selected initial period\end{matrix}}$$

Said first evolution ratio is suitably less than 4, preferably less than 3, more preferably less than 2. The ratio is suitably greater than 0.5, preferably greater than 0.8, and more preferably 1 or greater.

Said selected initial 5 day period may be within 45 days, suitably within 30 days, 15 days, 10 days or 5 days of filling of the container, for example with a beverage.

Said control means is preferably arranged to control a second evolution ratio, wherein the second evolution ratio is defined as:

$$\frac{the rate of evolution of hydrogen in the container over a selected initial 5 day period}{\begin{matrix}the rate of evolution of hydrogen in the container over a second 5 day period starting \\ 180 days after the end of the selected initial period\end{matrix}}$$

Said second evolution ratio is suitably less than 4, preferably less than 3, more preferably less than 2. The ratio is suitably greater than 0.5, preferably greater than 0.8, and more preferably 1 or greater

Said control means is preferably arranged to control a third evolution ratio, wherein the third evolution ratio is defined as:

$$\frac{the rate of evolution of hydrogen in the container over a selected initial 5 day period}{\begin{matrix}the rate of evolution of hydrogen in the container over a second 5 day period starting \\ 270 days after the end of the selected initial period\end{matrix}}$$

Said third evolution ratio is suitably less than 4, preferably less than 3, more preferably less than 2. The ratio is suitably greater than 0.5, preferably greater than 0.8, and more preferably 1 or greater.

Both the first and second evolution ratios may apply. Preferably, the first, second and third evolution ratios apply.

Suitably, in said container, the only path for passage of moisture, in use, from product in the container to the hydrogen generating means is via said control means. Said control means preferably defines an uninterrupted barrier between the hydrogen generating means and a source of moisture in the container.

Unless otherwise stated, water permeability described herein is measured using (American Society for Testing Materials Annual Book of Standards) ASTM procedure E96 Procedure E at 38° C. and relative humidity of 90%.

A said control means is suitably selected so that it defines the rate determining step for passage of moisture, for example water vapour, from a product in the container to the active material. Suitably, the rate of passage of moisture through the control means, towards the hydrogen generating means, is no faster than (e.g. it may be slower than) the rate of passage of water through the hydrogen generating means (e.g. through a matrix material thereof). Preferably, to achieve the aforesaid, the ratio of the water vapour permeability (g·mm/m²·day) of the control means divided by the water vapour permeability of the matrix material may be 1 or less, preferably 0.75 or less, more preferably 0.5 or less. In some situations, the control means and said matrix material comprise the same material, in which case the water vapour permeability through the respective materials may be substantially the same. In other situations, water vapour permeability of the control means may be such that the rate of passage of moisture through the control means, towards the hydrogen generating means, is faster than the rate of passage through the hydrogen generating means. Nonetheless in such situations the control means is still found to exercise control over hydrogen generation because the moisture “backs up” in the material of the control means; and it is found that the rate of hydrogen generation in the presence of such a control means is less than in the absence of such a control means.

In one embodiment, the ratio of the water vapour permeability (g·mm/m² day) of the control means divided by the water vapour permeability of the matrix material of the hydrogen generating means is 15 or less, 10 or less, 3 or less, or 2.6 or less. It may be in the range 0 to 15, 0 to 10 or 0 to 3.

At least part of said control means is preferably provided in a first layer. A second layer may comprise said hydrogen generating means. Said second layer may abut and/or contact (e.g. make face to face contact with) the first layer. Where the control means includes more than one layer, part of the control means may be defined by said first layer and part defined by another layer.

Said second layer may incorporate hydrogen generating means which may comprise a matrix with which said active material is associated, for example embedded or preferably dispersed. Said matrix may comprise a matrix material, for example a polymeric matrix material. Suitable matrix materials have a water vapour permeability of greater than 0.1 g·mm/m²·day, suitably greater than 0.2 g·mm/m²·day, preferably greater than 0.4 g·mm/m²·day, more preferably greater than 0.6 g·mm/m²·day, and especially greater than 0.8 g·mm/m²·day. In some cases, said water vapour permeability may be greater than 1.0 g·mm/m²·day. Said matrix material may comprise a blend comprising, for example, at least two polymeric materials. The water vapour permeability of said matrix material may be less than 5 g·mm/m²·day, less than 4 g·mm/m²·day or less than 3 g·mm/m²·day. Suitable polymeric matrix materials include but are not limited to ethylene vinyl acetate, styrene-ethylene-butylene (SEBS) copolymers, Nylon 6, styrene, styrene-acrylate copolymers, polybutylene terephthalate, polyethylene and polypropylene.

As described above, said catalyst may be associated with a closure of the container and/or may be associated with a container body of the container. When said catalyst is associated with a closure, said catalyst is preferably provided in a layer of said closure. When said closure includes a first layer and a second layer as described, said catalyst may be provided in said first and/or second layers and/or provided in a layer (e.g. a third layer) which may be as described in embodiment (A1). In any case, preferably, a barrier means, for example barrier material, is provided between a container body in which product is contained, in use, and catalyst in the closure, wherein said barrier means, for example barrier material, is suitably an integral part of the closure and, therefore, is removed from association with the container body if the closure is disengaged from the container body. Said barrier means may be as described in (AA), (BB) and/or (CC). When said barrier means comprises a barrier material as described in (AA), said barrier material may be provided as a separate layer and may, for example, define a first layer as described. When said barrier means comprises a barrier material as described in (BB) or (CC), in preferred embodiments, said catalyst may be arranged as described in embodiment (A2) or may be associated with a porous material as described in (BB). In both cases, composite particles may be defined, each of which comprises catalyst and barrier material. The composite particles may be dispersed within said first and/or said second layer of said closure. Preferably, said first layer includes said composite particles.

As described, in some embodiments, said barrier material may be associated with polymeric material (XX). Polymeric material (XX) may comprise, for example define, the first or second layers and, more preferably, defines said first layer which suitably provides said control means. Barrier means and/or barrier material may be associated with polymeric material (XX) as described in Examples (B1-i) and Example (B1-ii).

When said catalyst is associated with said container body, the container body may include a sidewall constructed from a composition that includes a polymer resin first component and a second component comprising a catalyst capable of catalyzing a reaction between molecular hydrogen and molecular oxygen. The catalyst suitably includes a barrier means, for example a barrier material, as described herein.

Because of the extremely high reaction rates obtainable with a number of catalysts, very small amounts of catalyst may be required. A container body may include 0.01 ppm to 1000 ppm, suitably 0.01 ppm to 100 ppm, preferably 0.1 ppm to 10 ppm, more preferably at least 0.5 ppm of catalyst relative to the weight of said container body (excluding any contents thereof). In preferred embodiments, 5 ppm or less of catalyst is included. Unless otherwise stated reference to “ppm” refer to parts per million parts by weight.

The small amount of catalyst needed allows even expensive catalysts to be economical. Moreover, because very small amounts are required to be effective, there can be minimal impact on other package properties, such as color, haze, and recyclability. For example, when palladium is utilized as the catalyst, concentrations less than about 1 ppm of finely dispersed Pd may be sufficient to achieve acceptable rates of oxygen scavenging. In general, the amount of catalyst required will depend on and can be determined from the intrinsic rate of catalysis, the particle size of the catalyst, the thickness of the container walls, the rates of oxygen and hydrogen permeation, and the degree of oxygen scavenging required.

In a preferred embodiment, the catalyst is incorporated into a wall of the container body. It is preferably associated with, for example dispersed in, a polymer which defines at least part of the wall of the container body. In a preferred embodiment, the catalyst is associated with material which defines at least 50%, preferably at least 75%, more preferably at least 90% of the area of the internal wall of the container body. In a preferred embodiment, the catalyst is distributed substantially throughout the entire wall area of the container body.

The container body may be a monolayer or a multilayer construction. In a multi-layered construction, optionally one or more of the layers may be a barrier layer. A non-limiting example of materials which may be included in the composition of the barrier layer are polyethylene co-vinyl alcohols (EVOH), poly(glycolic acid), and poly(metaxylylenediamine adipamide). Other suitable materials which may be used as a layer or part of one or more layers in either monolayer or multilayer containers include polyester (including but not limited to PET), polyetheresters, polyesteramides, polyurethanes, polyimides, polyureas, polyamideimides, polyphenyleneoxide, phenoxy resins, epoxy resins, polyolefins (including but not limited to polypropylene and polyethylene), polyacrylates, polystyrene, polyvinyls (including but not limited to poly(vinyl chloride)) and combinations thereof.

In a preferred embodiment, the container body includes walls defined by polyester, for example PET. When said catalyst is associated with said container body, preferably catalyst is dispersed within the polyester. Advantageously, due to the provision of the barrier material, the risk the catalyst may be poisoned by constituents of the resin is reduced. Consequently, catalyst and associated barrier material may solve the problem described in the introduction particularly in relation to container bodies comprising PET made using an antimony-based catalyst.

Said container body may include a permeable wall comprising of one or more polymers that have in the absence of any oxygen scavenging a permeability between about 6.5×10⁻⁷ cm³-cm/(m²-atm-day) and about 1×10⁴ cm³-cm/(m²-atm-day).

According to a third aspect of the invention, there is provided a closure for a container according to the second aspect, the closure comprising:
(i) a hydrogen generating means comprising an active material arranged to generate molecular hydrogen on reaction with moisture;
(ii) a catalyst capable of catalyzing a reaction between molecular hydrogen and molecular oxygen;
(iii) a barrier means for restricting passage of organic molecules to the catalyst, for example from a product contained, in use, in the container which may be associated with the closure.

Preferably, said closure includes a barrier means comprising:
(AA) a barrier material which has a Hildebrand Solubility Parameter (HSP) of less than 16.0 MPa^{1/2}; and/or
(BB) a barrier material which is a porous material, for example a microporous material which suitably includes pores with free diameters of less than 2 nm; and/or
(CC) a barrier material which surrounds individual particles of catalyst so that a mass of composite particles is defined, wherein each of said composite particles comprises catalyst surrounded by said barrier material.

Other features of the barrier means and/or closure may be as described any statement according to the second aspect.

In a preferred embodiment, at least part of a said control means is provided in a first layer and a second layer comprises said hydrogen generating means. A said catalyst is preferably provided in a layer of said closure. When said closure includes a first layer and a second layer as described, said catalyst may be provided in said first and/or second layers and/or provided in another layer (e.g. a third layer). In any case, preferably, a barrier means, for example barrier material, is suitably an integral part of the closure and, therefore, is arranged to be removed from association with a container body if the closure is disengaged from the container body.

According to a fourth aspect of the invention, there is provided a container body for a container of the second aspect, the body comprising:
(i) a catalyst capable of catalyzing a reaction between molecular hydrogen and molecular oxygen;
(ii) a barrier means for restricting passage of organic molecules from a product contained, in use, in the container, to the catalyst.

Preferably, said container body includes a barrier means comprising:
(AA) a barrier material which has a Hildebrand Solubility Parameter (HSP) of less than 16.0 MPa^{1/2}; and/or
(BB) a barrier material which is a porous material, for example a microporous material which suitably includes pores with free diameters of less than 2 nm; and/or
(CC) a barrier material which surrounds individual particles of catalyst so that a mass of composite particles is defined, wherein each of said composite particles comprises catalyst surrounded by said barrier material.

Said container body suitably comprises polyester as described herein in combination with said barrier material. Said barrier material may define an internal layer of the container which is suitably inwards of said polyester layer.

Other features of the barrier means and/or container body may be as described any statement according to the second aspect.

According to a fifth aspect of the invention, there is provided a method of restricting passage of organic molecules, for example benzaldehyde, from a product contained, in use, in a container to a catalyst which is part of the container and is arranged to catalyse a reaction between molecular hydrogen and molecular oxygen, the method comprising: providing a barrier means for restricting passage of organic molecules, for example benzaldehyde, said barrier means being positioned between a volume of said container in which the product is positioned in use and said catalyst for restricting passage of organic molecules, for example benzaldehyde, from a product contained, in use, in the container, to the catalyst.

The method of the fifth aspect may include any feature of any invention of any other aspect.

According to a sixth aspect of the invention, there is provided a method of constricting a barrier means for a closure or container body of a container, the method comprising:
(AAA) selecting barrier material which has a Hildebrand Solubility Parameter (HSP) of less than 16.0 MPa^{1/2} and arranging said barrier material in said closure to restrict passage of organic molecules to catalyst in said closure or arranging said barrier material in said container body to restrict passage of organic molecules to catalyst in said container body; or
(BBB) selecting a barrier material which is a porous material, for example a microporous material which suitably includes pores with free diameters of less than 2 nm and arranging said barrier material in said closure to restrict passage of organic molecules to catalyst in said closure or arranging said barrier material in said container body to restrict passage of organic molecules to catalyst in said container body; or

(CCC) selecting a barrier material which surrounds individual particles of catalyst so that a mass of composite particles is defined, wherein each of said composite particles comprises catalyst surrounded by said barrier material and arranging said composite particles in said closure or arranging said composite particles in said container body.

According to a seventh aspect of the invention, there is provided the use of a barrier means as described herein for restricting passage of organic molecules, for example benzaldehyde from a product.

Any feature of any aspect of any invention or embodiment described herein may be combined with any feature of any aspect of any other invention or embodiment described herein mutatis mutandis.

### SPECIFIC EMBODIMENTS

Specific embodiments of the invention will now be described, by way of example, with reference to the accompanying drawings, in which:

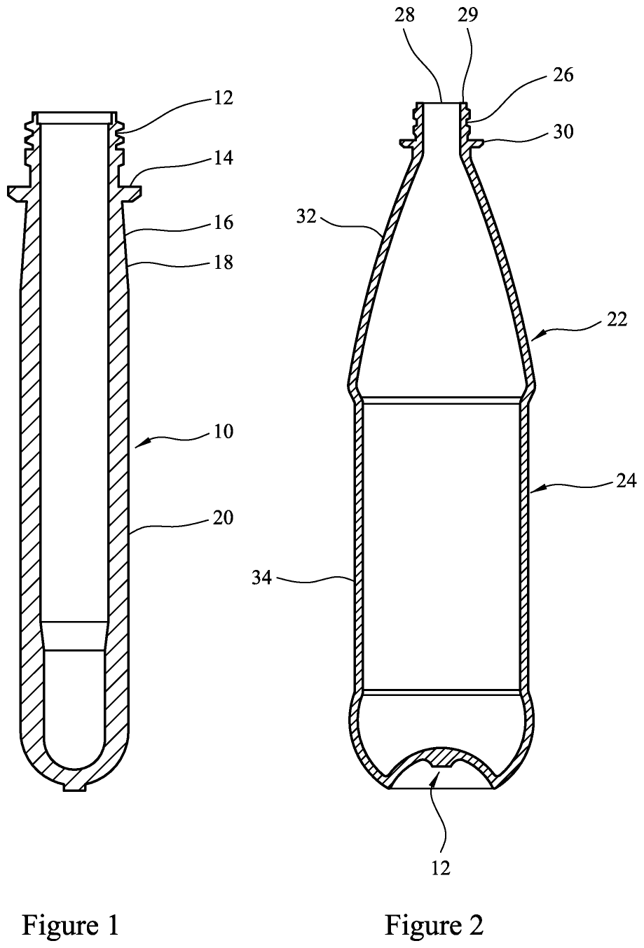

FIG. 1 is a cross-section through a preform;

FIG. 2 is a cross-section through a bottle;

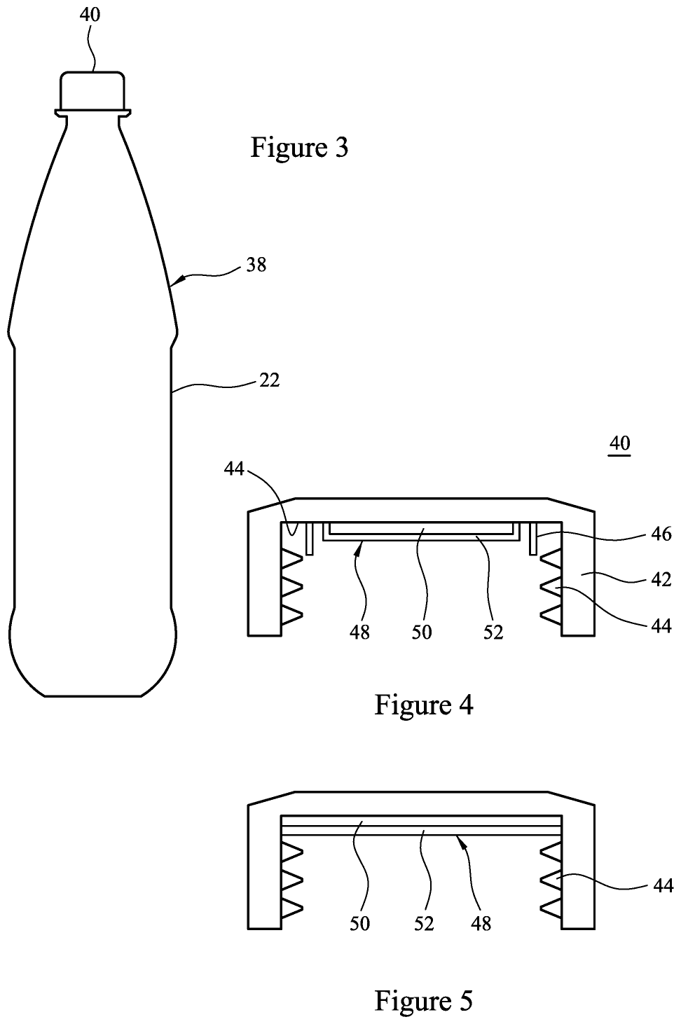

FIG. 3 is a side elevation of a bottle including a closure;

FIGS. 4 to 7 are side elevations, partly in cross-section, of various closures;

FIG. 8 is a schematic representation of a closure in a jar during a test;

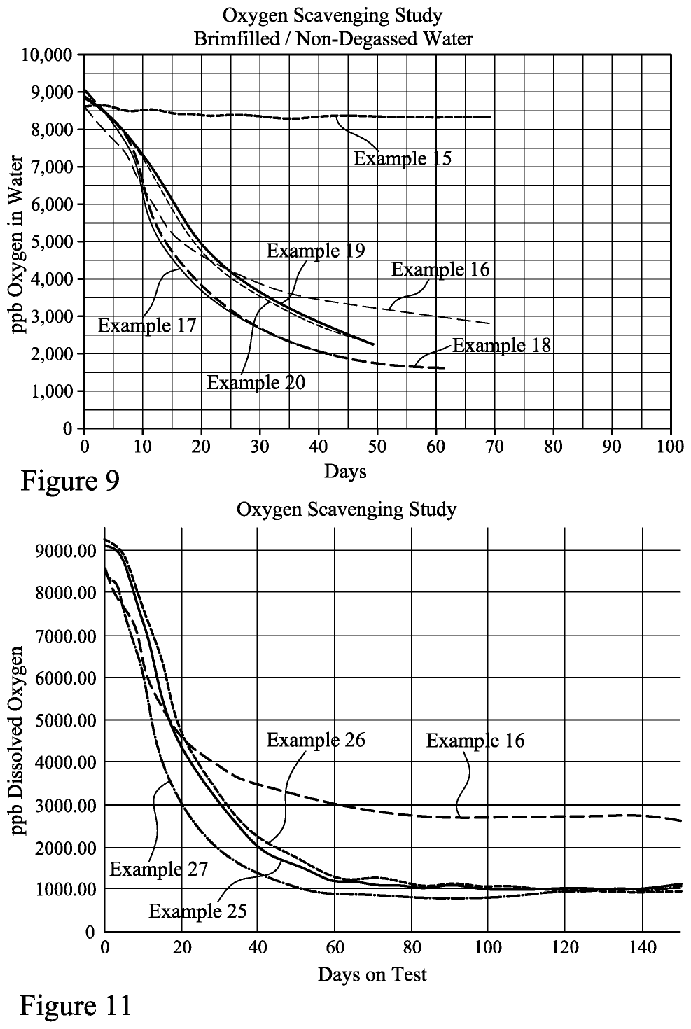

FIG. 9 is a graph of amount of oxygen in water v. time for a range of different closures;

FIGS. 10a and 10b are plan views of a film/laminate within a container; and

FIG. 11 is a graph of amount of oxygen in water v. time for different closures.

In the figures, the same or similar parts may be annotated with the same reference numerals.

The following materials are referred to hereinafter:
Dow 722—refers to low density polyethylene (LDPE) from Dow;
Petrothene—refers to low density polyethylene (LDPE) NA 86008 from Lyondell Basell;
Vistamaxx—refers to Vistamaxx 6102, a propylene elastomer having a Melt Index, measured by ASTM D1238, of 1.4 g/10 min, from Exxon Mobil;
Vistamaxx 6202—refers to Vistamaxx 6202, a propylene elastomer having a Melt Index, measured by ASTM D1238, of 9.1 g/10 min, from Exxon Mobil;
Vistamaxx 6502—refers to Vistamaxx 6502, a propylene elastomer having a Melt Index, measured by ASTM D1238, of 21 g/10 min, from Exxon Mobil;
D9506—refers to DOWSIL™ 9506 which is a spherical white powder comprised of dimethicone/vinyl dimethicone crosspolymer, manufactured using a platinum catalyst for a hydrosilylation reaction as described generally in U.S. Pat. No. 9,561,171. The platinum content is about 10 ppm.
Westlake LDPE—low density polyethylene obtained from Westlake Chemicals.
Calcium hydride (purity 99%)—from Sigma-Aldrich.

Hildebrand Solubility Parameters are described herein. The Hildebrand solubility parameter (δ) provides a numerical estimate of the degree of interaction between materials. The Hildebrand solubility parameter is the square root of the cohesive energy density:

$$δ = \sqrt{\frac{Δ {H}_{v} - RT}{{V}_{m}}} .$$

The cohesive energy density is the amount of energy needed to completely remove unit volume of molecules from their neighbours to infinite separation (an ideal gas). This is equal to the heat of vaporization of the compound divided by its molar volume in the condensed phase. In order for a material to dissolve, these same interactions need to be overcome, as the molecules are separated from each other and surrounded by the solvent. Materials with similar solubility parameters will be able to interact with each other, resulting in solvation, miscibility or swelling.

Unless otherwise stated herein, parts per million (ppm) or parts per billion (ppb) or similar expressions herein refer to the parts on a weight-weight basis.

A preform 10 illustrated in FIG. 1 can be blow molded to form a container body 22 illustrated in FIG. 2. The container body 22 comprises a threaded neck finish 26 defining a mouth 28, a capping flange 30 below the threaded neck finish, a tapered section 32 extending from the capping flange, a cylindrical body section 34 extending below the tapered section, and a base 12 at the bottom of the container body. The container body 22 together with a closure 40 are used to define a container 38 which may contain a beverage, as illustrated in FIG. 3. In one embodiment, the beverage is an oxygen sensitive beverage which suitably includes a range of flavor components, some of which may be sensitive to reducing conditions. The beverage is disposed in the container body 22 and closure 40 seals the mouth 28 of the container body 22 to define container 38.

Referring to FIG. 4, a circular cross-section closure 40 is shown which includes a closure shell 42 with a screw-threaded portion 44 for screw-threadedly engaging the closure with threaded neck finish 26. Within the diameter of a sealing well 46 is a disc-shaped insert 48 which is moulded to inwardly facing wall 49 of shell 42. The insert 48 may include an inner layer 50 and an outer layer 52. The outer layer is suitably overmoulded around layer 50 suitably so that layer 50 is fully encapsulated. In general terms, layer 50 may include calcium hydride dispersed within LDPE and layer 52 may include a catalyst dispersed in a matrix material.

In use, with container 38 including a beverage and closure 40 in position, the headspace in the container will be saturated with water vapor. This vapor passes into liner 46 and contacts the calcium hydride associated with the liner. As a result, the calcium hydride produces molecular hydrogen which undergoes a catalyzed reaction with oxygen which may have entered the container through its permeable walls, to produce water. Thus, oxygen which may ingress the container is scavenged and the contents of the container are protected from oxidation. The scavenging effect may be maintained for as long as hydrogen is produced in the container and such time may be controlled by inter alia varying the amount of hydride in the liner.

It has, however, been found that not only does the catalyst catalyse the reaction of hydrogen and oxygen to produce water but it may also catalyse other undesirable oxidization, reduction and/or isomerisation reactions involving organic components of the beverage contained in the container. Such organic components may migrate into and out of, for example, layers 50, 52 of insert 48 and reaction products may enter the beverage.

Clearly, the products of catalysed reactions depend on what molecules are present in a particular beverage provided in a container. By way of example, many fruit beverages include benzaldehyde. A container which includes a closure comprising a palladium catalyst for catalysing a reaction between hydrogen and oxygen as aforesaid, was assessed. The container was first filled with a benzaldehyde solution to simulate a product including a flavour component. It was found, after storage for 60 days, there was a 6.9% conversion of benzaldehyde to benzyl alcohol (via a hydrogenation reaction) and 0.4% conversion to toluene (via hydrogenolysis of benzyl alcohol). Both of the reactions are undesirable. As a generality, it is desirable to limit/prevent any and all palladium catalysed reactions of components of products provided in containers of the type described.

The description and examples which follow illustrate how undesirable reactions of components present in beverages in a container may be investigated and/or how they may be reduced to limit the production of potentially undesirable contaminants, whilst not substantially impeding the required oxygen scavenging reaction involving hydrogen and oxygen.

In general terms, preferred embodiments provide a barrier between a product in a container (in particular small organic molecules which are components of the product and may be released therefrom) and a catalyst associated with a closure or body wall of the container. In preferred embodiments, the catalyst is provided in a closure. The barrier may be provided as described in (A) to (C) below.

### (A) Use of Catalyst Isolated in a Microporous Material

In general terms, a catalyst may be incorporated in the pore structure of a microporous material to produce a combination which can be mixed into a thermoplastic polymer and extruded or moulded to produce a film which may then be incorporated into a closure, for example as layer 52 which is provided outside hydride-containing layer 50, as shown in FIG. 5. The microporous material may be inorganic or organic in nature and is more preferably, inorganic. The microporous material may comprise a zeolite in which catalyst is dispersed. The size of the pores in the zeolite and its hydrophilicity are suitably selected so that organic molecules such as benzaldehyde are restricted from passing through the zeolite to the catalyst and yet hydrogen, oxygen and water can relatively freely pass through the zeolite-containing film layer 52.

The pore size of the microporous material, for example zeolite, may be in the 5-10 Angstroms.

Zeolithic structures may be formed by a range of elements including germanium, gallium, indium, phosphorous and carbon. Preferred microporous materials are natural or synthetic zeolites.

Preferred microporous materials have a relatively hydrophilic environment inside the material, for example zeolite, which helps to exclude organic molecules and encourage passage of, for example water. The hydrophilic environment may be inherent or an additional material may be associated with the zeolite to create the desired environment.

Preferred zeolites have a hydrophilic internal environment which may be created by presence of Group I or Group II aluminates. The Si/Al ratio affects the hydrophilicity of zeolites. Preferred zeolites have a Si/Al ratio of less than 2, for example less than 1.5. Preferably, the counter-ion to the AlO₂⁻⁻ moieties are Na or Ca. Preferred zeolites are NaX, CaX or CaA. CaA tends to be highly hydrophilic and may be preferred in some cases.

Whilst the microporous material, for example zeolite, may be microporous/zeolitic throughout the body of the structure, zeolitic particles having a zeolitic exterior but an amorphous/non-zeolitic interior may be used in preparation of the zeolite/catalyst combination.

The mechanism of action of microporous materials to restrict passage of organic molecules may be two-fold—firstly, based on the porous structure restricting the molecules based on size; and, secondly, based on hydrophilic/hydrophobic properties of the porous structure.

### (B) Encapsulation of Catalyst in Polymer

In general terms, a catalyst may be encapsulated in a suitable polymer and then the catalyst/polymer combination can be dispersed in a suitable thermoplastic matrix polymer (e.g. a polyolefin) and extruded or moulded to produce a film which may then be incorporated into a closure, for example as layer 52 in FIG. 5. Selected polymers for the catalyst/polymer combination may have a relatively low solubility parameter in comparison to the organic molecules it is desired to exclude from contact with the encapsulated catalyst. Examples of suitable polymers include silicone resins and/or silicone rubber. Silicones have a Hildebrand Solubility Parameter of 15.0 MPa^{1/2} which is relatively low in comparison to the solubility parameter of organic molecules it is desired to exclude from contact with the catalyst. For example, benzaldehyde has a Hildebrand Solubility Parameter of 19.2 MPa^{1/2}. So, the solubility of benzaldehyde in silicone is relatively low meaning the passage of benzaldehyde through silicone which may be used to encapsulate the catalyst will be relatively low and/or significantly restricted. In contrast, the Hildebrand Solubility Parameter of polyethylene in which the catalyst/polymer (e.g. silicone) combination may be dispersed, is 17.0 MPa^{1/2}. Thus, the solubility of benzaldehyde in the matrix (i.e. polyethylene) will be greater than its solubility in the polymer (i.e. silicone) of the catalyst/polymer combination. Thus, the benzaldehyde is relatively restricted from passing through the polymer of the catalyst/polymer combination and is therefore relatively restricted from contacting the catalyst. Thus, in general terms, whilst organic molecules may pass into the thermoplastic polymer matrix, such molecules are restricted from contacting the catalyst by virtue of the relatively low solubility of organic molecules in the polymer which encapsulates the catalyst. However, hydrogen and oxygen (solubility parameters in the range 7-8 MPa^{1/2}) are found still to be able to approach the catalyst and undergo a reaction, catalysed by said catalyst, to produce water (solubility parameter 47.9 MPA^{1/2}).

The encapsulated catalyst may be made as described in Reference Example 1 of U.S. Pat. No. 9,561,171 and the content of column 13, line 56 to column 14, line 19 of U.S. Pat. No. 9,561,171 is incorporated herein by this reference. As will be appreciated, the example describes preparation of silicone rubber particles of average diameter 6.2 μm, containing 7.2 ppm by mass of platinum metal (Pt).

In general terms, the silicone resin used may be based on any vinyl-substituted silicone or silicon hydride, such as polymethylhydrosiloxane.

The catalyst may be used in the polymerisation process to produce the silicone resin. The catalyst remains in the silicone resin after catalysing the polymerisation process and is therefore available for catalysing the reaction of hydrogen and oxygen as described.

The encapsulated catalyst, suitably having an average (D₅₀) particle size in the range 1 to 100 μm, suitably in the range 3 to 30 μm, may be mixed with thermoplastic matrix polymer as described to provide 1 to 1000 ppm, suitably 10 to 50 ppm, of catalyst in the film produced which is then used for layer 52 of the closure.

It is found that the encapsulated platinum catalyst is dispersed in the silicone at a molecular level with no detectable clusters. As a result, the activity of the catalyst is optimised and lower amounts of catalyst may be used in the thermoplastic matrix polymer of layer 52 than in comparable situations wherein the catalyst is less well dispersed.

Other polymers with sufficiently different Hildebrand Solubility Parameters compared to the organic molecules it is desired to restrict from contacting the catalyst may be used as alternatives to silicone resins. For example, catalyst may be dispersed in a fluoropolymer resin, such as PTFE which has a solubility parameter of 12.7 MPa^{1/2}. Such a combination may be used to produce a film which may then be incorporated in a closure, for example as layer 52 in FIG. 5. Alternatively, a mixture of catalyst and fluoropolymer resin may be mixed with another thermoplastic matrix polymer, for example, EVA (solubility parameter 17.0 MPa^{1/2}) or similar polymer, and the latter mixture extruded or moulded to produce a film which may be incorporated in a closure as layer 52 as described.

### (C) Use of Layer to Restrict Access to Catalyst

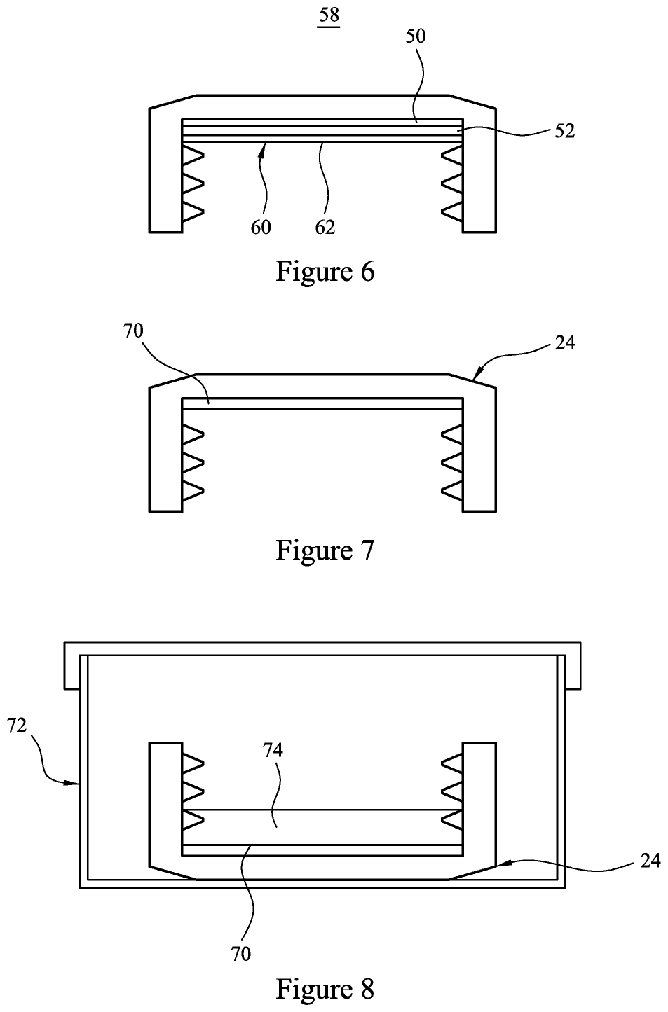

As an alternative to the arrangement described in (B), referring to FIG. 6, a closure 58 includes an organophobic layer 62 which is provided as an outermost layer of an insert 60 which also comprises inner layer 50 (which includes a hydride arranged to generate hydrogen) and second layer_52 (which includes a catalyst) as described with reference to FIGS. 4 and 5. The organophobic layer 62 acts as a barrier (which is arranged to restrict passage of organic molecules) between the contents of a container and the catalyst in layer 52. The organophobic layer is selected such that it has a Hildebrand Solubility Parameter which is relatively low in comparison to the solubility parameter of organic molecules (e.g. benzaldehyde) it is desired to restrict from contact with said catalyst. For example, the organophobic layer may comprise a fluoropolymer. Alternatively layer 62 may comprise a sulphonated polymer. Thus, organic molecules which may be present in the head space of the container including a closure 58 are relatively insoluble in the material of the organophobic layer 62 and consequently passage of such molecules to catalyst in layer 52 is substantially restricted.

The organophobic layer 62 may be provided as a discrete layer upon underlying layer 52 by suitable means. For example, layer 62 may be applied by compression moulding, injection moulding, co-extrusion or solvent deposition. As an alternative, the outer surface of a layer 52 may be functionalised to increase its organophobicity and/or lower its Hildebrand Solubility Parameter.

In one embodiment, layer 62 may comprise a fluoropolymer layer which may be applied as a discrete layer onto layer 52. Alternatively, the outer surface of layer 52 may be post-fluorinated, for example by exposure of a closure including layer 52 to fluorine gas for example as described in US20190040219 A1, the content of which as regards the fluorination method is incorporated herein by reference.

Although the barriers referred to in (A) to (C) have been described as restricting passage of organic molecules to catalyst in a closure, when catalyst is provided in a side wall of a container body 22, for example as described in WO2008/090354A1, a barrier may be associated with the side wall to restrict passage of organic molecules as aforesaid. For example, catalyst may be encapsulated in a microporous material as described in (A) or in a polymer as described in (B) and incorporated in the side wall. Alternatively, the side wall of the container body may include an internal layer as described in (C). Such a layer may be conveniently provided by post-fluorination of the innermost layer of a container body.

The general procedures referred to above are further illustrated in the following examples.

### EXAMPLE 1

### General Procedure for Preparation of Test Samples

Referring to FIG. 7, test samples are prepared comprising a disc of test material 70 secured within an inert closure shell 24. The disc may be formed by in-shell lining, wherein a pellet of material arranged to define the test material is injected into the shell 24 and compressed

In general terms, test materials are prepared by dry blending a mixture of a selected catalyst composition with pulverised Petrothene (polyethylene) and Vistamaxx (propylene) pellets. This mixture is then melt compounded in a twin-screw extruder with a barrel temperature of 180° C. and a residence time of 43 seconds. The extrudate is cooled in a water bath, the surface moisture is removed with an air knife and the dried strand is pelletized. The pellets are stored in a foil-lined bag to prevent moisture uptake prior to manufacture of test samples.

### EXAMPLE 2

### Preparation of 0.20 wt % Pt/NaX (Catalyst/Zeolite Combination)

The following steps are undertaken:
(i) 250 grams of dry NaX zeolite are hydrated. Moisture uptake should be about 75 grams. The zeolite average particle size preferably should be <3 microns.
(ii) The hydrated zeolite is suspended in 1 litre of distilled water, with continuous stirring to prevent settling of the zeolite powder into a cake.
(iii) 0.89 grams of Pt(NH₃)₄Cl₂ (56 wt % Pt) is dissolved in 50 ml of 3% NH3-H₂O. A small amount of fluffy solids may form.
(iv) The Pt solution is added to the stirred zeolite suspension by pouring through filter paper (to trap undissolved material).
(v) The filter paper is rinsed with another 50 ml of 3% NH₃—H₂O, then with distilled water. All the rinsings are be added to the stirred zeolite suspension.
(vi) The mixture is stirred for about 40 hours at room temperature to effect ion-exchange.
(vii) The suspension is filtered through a Whatman Grade 5 or equivalent filter.
(viii) Solids are rinsed with 500 ml distilled water.
(ix) The rinsed filter cake is transferred to a Coors dish and dried on a steam bath until a dry powder (of approximately 20% moisture content) is obtained.
(x) The product is calcined at 230° C. in air for 6 hours or until moisture content is about 3%.
(xi) The calcined powder is transferred to sealed containers that are resistant to moisture permeation (e.g. polyethylene bags or drums).

As an alternative, the ion-exchanged product from step (vi) may be sent directly to a drier to reduce moisture content to about 20%, followed by step (x).

### EXAMPLE 3

### Preparation of 0.20 wt % Pd/NaX (Catalyst/Zeolite Combination)

The procedure of Example 2 was used, replacing Pt(NH₃)₄Cl₂ with Pd(NH₃)₄Cl₂.

### EXAMPLES 4-11

### Preparation of Specific Test Materials

Following the general procedure described in Example 1, the following test samples were prepared:

| Example | Description |
|---|---|
| 4 | Laminate comprising base layer of Dow 722 and cover layer comprising |
| | compounded mixture of Vistamaxx and Petrothene in ratio 70:30. This is a |
| | negative control. |
| 5 | Compounded mixture of resins Vistamaxx and Petrothene in 70:30 ratio and |
| | Pd(OAc)₂ (20 ppm based on weight of resins). This is a positive control. |
| 6 | Compounded mixture of resins Vistamaxx and Petrothene in 70:30 ratio and |
| | catalyst/zeolite combination of Example 3, to deliver 100 ppm of palladium-. |
| 7 | Compounded mixture of resins Vistamaxx and Petrothene in 70:30 ratio and |
| | catalyst/zeolite combination of Example 2, to deliver 200 ppm of platinum. |
| 8 | Compounded mixture of resins Vistamaxx and Petrothene in 70:30 ratio and |
| | 200 ppm of PtO₂ (unsupported catalyst) |
| 9 | Comparative mixture of resins Vistamaxx and Petrothene in 70:30 ratio and 200 |
| | ppm of Pt on AlO₃ comprising 5 wt % Pt and 95 wt % Al₂O₃. |
| 10 | Comparative mixture of resins Vistamaxx and Petrothene in 70:30 ratio and 200 |
| | ppm of Pt on CaCO₃ comprising 5 wt % Pt and 95 wt % CaCO₃) |
| 11 | Compounded mixture formed by compounding pellets comprising Vistamaxx |
| | and Westlake LDPE in 92:8 ratio and D9506 so the combination comprised |
| | D9506 (7.5 wt %), Vistamaxx (85 wt %) and Westlake LDPE (7.5 wt %). |
| | Note the D9506 itself includes 10 ppm Pt as described above |

### EXAMPLE 12

### Preparation of Closures for Testing

Following the general procedure of Example 1, the test materials of Examples 4 to 11 were made into closures as described in FIG. 7.

### EXAMPLE 13

### Testing of Closures

Referring to FIG. 8, each of the closure samples 24 was placed, upturned, in an individual glass jar 72. 10.134 g of benzaldehyde solution (300 mg/kg) (ref numeral 74) was then transferred using a glass pipette onto the facing layer or inner surface of each sample. Once the liquid was added, the jars were sealed and stored at 20° C. until ready for testing. For each closure type, enough closures were prepared for multiple sampling at each time point.

At the point of test, each jar 72 was opened and 6 g (+/−0.02 g) of solution was transferred from the facing of the closure to a 9 ml high-recovery GCMS vial. The vial was then capped with a magnetic closure and placed in an autosampler tray ready for extraction and testing. Note that a small quantity of condensation was present inside each jar through the test, which is largely unavoidable when storing samples at room temperature.

The aqueous samples were extracted using a written automated program carried out by a Gerstel MPS Autosampler. Dispersive Liquid-Liquid micro-extraction was carried out on each sample by addition of 300 μl of dichloromethane and 150 μl of isopropyl alcohol followed by vortex mixing and finally centrifugation to form an extractant solvent droplet (lower layer). A large volume injection (LVI) (10 μl+) of the extractant solvent was carried out into a cooled GC inlet (PTV) to minimise both thermal degradation of the analytes and evaporative losses. Controlled evaporation in the GC inlet removes the solvent and concentrates the analyte for detection. A solvent-sample ‘sandwich’ injection approach was used to improve injection reproducibility and optimise the concentration of analytes on the column.

Detection of toluene was confirmed using selected reaction monitoring (SRM). An SRM approach on a triple quadrupole instrument selects a precursor ion using the MS1 quadrupole and following collision at a controlled energy in the collision cell, a characteristic product ion is selected by the MS2 quadrupole. This combination of procedures allows specific and accurate ppb quantification of the analyte.

### Results for Example 13

The results of the tests described in Example 13 are provided in the table below.

| | Bulk | Example | Example | Example | Example | Example | Example | Example | Example |
|---|---|---|---|---|---|---|---|---|---|
| Days | sol. | 4 | 5 Pt Ace | 6 Pd Zeo | 7 Pt Zeo | 8 | 9 | 10 | 11 |
| 0 | 0.42 | 0.42 | 0.42 | 0.42 | 0.42 | 0.42 | 0.42 | 0.42 | 0.42 |
| 1 | 0.38 | 0.42 | 1.08 | 0.70 | 0.37 | 2.94 | 8.74 | 2.65 | 0.50 |
| 3 | 0.62 | 0.49 | 6.38 | 2.26 | 0.81 | 10.6 | 33.1 | 9.94 | — |
| 10 | 0.50 | 0.69 | 20.6 | 2.43 | 0.86 | 17.0 | 64.1 | 29.5 | — |
| 14 | 0.46 | 0.48 | 26.8 | 3.26 | 1.24 | 34.8 | 43.2 | 35.4 | 1.38 |

In the table the values represent the toluene concentration (in parts per billion by weight (ppb)) in the benzaldehyde solutions taken at intervals from the closures following storage for up to 14 days (336 hours).

In the table the column headed “Bulk sol.” refers to benzaldehyde solution alone. The following is noted:
Example 4 shows the toluene concentration of the control (no catalyst) remains constant in line with that of the “Bulk sol.” example.
Example 5 shows that in a closure comprising catalyst without any barrier toluene is generated over the course of the test, leading to a high level (26.8 ppb) after 14 days.
Examples 6 and 7 show that dispersion of catalyst within a zeolite significantly reduces the amount of toluene produced compared to examples 5, 8, 9 and 10.
Example 8 shows that unsupported platinum catalyst, without any barrier, results in generation of significant amounts of toluene over the course of the test.
Example 9 shows that platinum supported on Al₂O₃, without any barrier, results in generation of significant amounts of toluene over the course of the test.
Example 10 shows that platinum supported on CaCO₃ without any barrier, results in generation of significant amounts of toluene over the course of the test.
Example 11 shows that dispersion of catalyst within a silicone significantly reduces the amount of toluene produced compared to examples 5, 8, 9 and 10.

The catalyst material of Examples 8 to 10 may, in alternative embodiments, be provided with a barrier means of a type as described herein.

TPV and TPV-UA as described herein may be calculated as follows from data for Examples 7 and comparative example 5.

The test material in each case has a 25.4 mm diameter facing layer with a surface area of 5.067 cm².

The volume of 300 ppm benzaldehyde solution added was 2 ml per cm² of surface area=5.067*2=10.134 ml of benzaldehyde solution added.

60% of volume of benzaldehyde solution removed after fixed time period (24 hours or 72 hours as applicable)=6.08 ml for testing.

Calculation of TPV for the Example 7 closure.

TPV (24 hrs)=0.00375(0.00037*10.134 [volume of benzaldehyde solution added to closure in ml])

TPV (72 hrs)=0.00821(0.00081*10.134 [volume of benzaldehyde solution added to closure in ml])

Calculation of TPV for the Example 5 closure.

TPV (24 hrs)=0.0109(0.00108*10.134 [volume of benzaldehyde solution added to closure in ml])

TPV (72 hrs)=0.0647(0.00638*10.134 [volume of benzaldehyde solution added to closure in ml])

Calculation of TPV-UA for the Example 7 closure.

| | | |
|---|---|---|
| TPV 24 hrs = 0.00375 | Area in cm² = 5.067 | 0.00375/5.067 = 7.4 × 10⁻⁴ |

TPV-UA 24 hrs = 7.4 × 10⁻⁴ mg/cm²

| | | |
|---|---|---|
| TPV 72 hrs = 0.00821 | Area in cm² = 5.067 | 0.00821/5.067 = 1.6 × 10⁻³ |

TPV-UA 72 hrs = 1.62 × 10⁻³ mg/cm²

Calculation of TPV-UA for the Example 5 closure.

| | | |
|---|---|---|
| TPV 24 hrs = 0.0109 | Area in cm² = 5.067 | 0.0109/5.067 = 2.15 × 10⁻³ |

TPV-UA 24 hrs = 2.15 × 10⁻³ mg/cm²

| | | |
|---|---|---|
| TPV 72 hrs = 0.0647 | Area in cm² = 5.067 | 0.0647/5.067 = [symbol] 1.27 × 10⁻² |

TPV-UA 72 hrs = 1.27 × 10⁻² mg/cm².

Examples 14 to 20 describe an alternative barrier of a type described in (C) above.

### EXAMPLE 14

Palladium acetate was dispersed into acetyl tributyl citrate at a 1 wt % loading, and the resulting dispersion was melt-blended with a 23% LDPE/77% Vistamaxx elastomer resin at a let-down ratio of 0.2% to provide a polyolefin blend containing 20 ppm Pd (hereinafter referred to as “HyCat”). Separately, calcium hydride was blended with LDPE to provide a hydride compound containing 21.6 wt % CaH₂ (hereinafter referred to as “HyCom”).

### EXAMPLE 15

38 mm closures were compression molded with a 25 mil thick HyCom base layer.

### EXAMPLE 16

Some of the closures from Example 15 were subsequently overmolded with a 15 mil thick HyCat layer.

### EXAMPLE 17

Some of the closures from Example 16 were subjected to fluorination to a fluorination level of 1 (equivalent to decreasing the permeation rate of benzaldehyde by a factor of 2). Fluorination was carried out as described in US2019/0040219 A1.

### EXAMPLE 18

Some of the closures from Example 16 were subjected to fluorination as described in Example 17, to a fluorination level of 5 (equivalent to decreasing the permeation rate of benzaldehyde by a factor of 10).

### EXAMPLE 19

Some of the closures from Example 16 were subjected to fluorination as described in Example 17, to a fluorination level of ˜10.

### EXAMPLE 20

Some of the closures from Example 16 were subjected to fluorination as described in Example 17, to a fluorination level of ˜20 .

### EXAMPLE 21

Closures from Examples 15-20 were fitted onto 500 ml heatset PET bottles that had each been fitted with an OxyDot™ and brim-filled with air-saturated water. The oxygen concentration of the water was tracked over time. The results are presented in FIG. 9. Referring to the figure, the results clearly show there is no negative impact on oxygen scavenging as a result of the fluorination process; in fact there appears to be enhanced activity for Examples 17 to 20, possibly from the impact of residual HF on the palladium catalyst.

### EXAMPLE 22

To 500 ml heat-set PET bottles was added a water solution of ˜300 ppm benzaldehyde at 84° C. The bottles were then capped with 38 mm closures containing no HyCat or HyCom (Virgin Liner), or with closures from Examples 15-20. The bottles were then stored at 40° C. for 14 days and analyzed for the presence of benzaldehyde, benzyl alcohol, and toluene. The results were normalized to 100 ppm benzaldehyde.

| | Benzaldehyde | Benzyl alcohol | Toluene |
|---|---|---|---|
| Closure Example | (ppm) | (ppm) | (ppm) |
| Virgin Liner | 100.000 | 0.000 | 0.000 |
| From Example 15 | 100.000 | 0.055 | 0.000 |
| From Example 16 | 100.000 | 1.992 | 0.144 |
| From Example 17 | 100.000 | 0.404 | 0.033 |
| From Example 18 | 100.000 | 0.060 | 0.021 |
| From Example 19 | 100.000 | 0.007 | 0.009 |
| From Example 20 | 100.000 | 0.004 | 0.006 |

As can be seen from the results, in the absence of HyCat and HyCom (Virgin Liner), no hydrogenation of benzaldehyde was observed. In the presence of HyCom only (Example 15), there was a trace of benzyl alcohol formed, likely resulting from a base-catalyzed Cannizzaro reaction. In Example 16 (HyCat+HyCom) there was a small but significant amount of hydrogenation of benzaldehyde to benzyl alcohol, and further hydrogenolysis of benzyl alcohol to toluene. In Example 17 (HyCat+HyCom+level 1 fluorination) the amount of benzyl alcohol and toluene formation is markedly decreased. In Example 18 (HyCat+HyCom+level 5 fluorination) the amount of hydrogenation is reduced even further. Examples 19 and 20 show that further increasing the level of fluorination results in ever-decreasing rates of formation of toluene. These results demonstrate the efficacy of the fluorinated barrier material in decreasing the degree of byproduct formation in the oxygen scavenging reaction.

### EXAMPLE 23

A 1% solution of palladium acetate in acetyl tributyl citrate is compounded into poly(vinylidene fluoride) at a let down ratio of 1.0%. The resulting fluoropolymer compound is melt-blended with LDPE at a 20:80 ratio to prepare a HyCat blend containing 20 ppm Pd. This HyCat blend is compression molded onto closures from Example 15 and the resulting closures are tested for oxygen scavenging and benzaldehyde reduction. The closures are found to exhibit reduced benzaldehyde hydrogenation (and reduced production of toluene) relative to closures from Example 18.

In the following, Example 24 describes an alternative method of preparing a catalyst/zeolite combination and subsequent examples describe use and testing of alternative materials combinations.

### EXAMPLE 24

### Preparation of 0.20 wt % Pt/NaX (Catalyst/Zeolite Combination) (Second Method)

The method of Example 2 is generally followed, with the following changes:

In steps (iii) and (v), distilled water is used instead of 3% NH3-H₂O; step (vi) is carried out for about 48 hours; and calcination in step (x) is carried out at 300° C. instead of 230° C.

In addition, Pt(NH₃)(NO₃)₂ may be substituted for Pt(NH₃)Cl₂, although Pt(NH₃)Cl₂ was used in the examples which follow.

### EXAMPLES 25 to 27

### Preparation of Specific Test Materials

Following the general procedure described in Example 1, the following test samples were prepared:

| Example | Description |
|---|---|
| 25 | Compounded mixture of resins Vistamaxx 6202 and |
| | Petrothene in 78:22 ratio and catalyst/zeolite |
| | combination of Example 2, to deliver 200 |
| | ppm of palladium-. |
| 26 | Compounded mixture of resins Vistamaxx 6502 and |
| | Petrothene in 78:22 ratio and catalyst/zeolite |
| | combination of Example 2, to deliver 200 |
| | ppm of platinum. |
| 27 | Compounded mixture of resins Vistamaxx 6202 and |
| | Petrothene in 78:22 ratio and catalyst/zeolite |
| | combination of Example 24, to deliver 200 |
| | ppm of platinum. |

### EXAMPLE 28

Following the procedure described in Example 21, closures based on materials of Examples 25 to 27 were assessed and the results are presented in FIG. 11. The results show some improvement through use of the Example 24 zeolite and alternative Vistamaxx/Petrothene combinations.

### EXAMPLE 29

Following the procedure described in Example 22, bottles were analysed for the presence of benzaldehyde, benzyl alcohol, and toluene and the results are provided below.

| | Benzaldehyde | Benzyl alcohol | Toluene |
|---|---|---|---|
| Closure Example | (ppm) | (ppm) | (ppm) |
| Virgin Liner | 100.000 | 0.000 | 0.000 |
| From Example 25 | 100.000 | 0.206 | 0.006 |
| From Example 26 | 100.000 | 0.212 | 0.144 |
| From Example 27 | 100.000 | 0.070 | <0.004 |

Results show that all three Vistamaxx grades described herein offer acceptable oxygen scavenging and resistance to flavor scalping performance. Grades 6202 and 6502 are higher MFI grades and are found to provide improved processability in a closure compression molding process by virtue of promoting extrudate tack, thereby eliminating the potential for compound extrudate pellet from bouncing out from the underside of closures just prior to compression molding.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A closure for a container, the closure comprising:
(i) a hydrogen-generating means comprising an active material arranged to generate molecular hydrogen on reaction with moisture:
(ii) a catalyst capable of catalyzing a reaction between molecular hydrogen and molecular oxygen:
(iii) a barrier means for restricting passage of organic molecules to the catalyst:
wherein said closure has a toluene production value (TPV) of less than 0.00800 mg after 24 hours; and/or wherein said closure has a toluene production value (TPV) of less than 0.04000 mg after 72 hours.

2. A container comprising:
(i) a hydrogen generating means comprising an active material arranged to generate molecular hydrogen on reaction with moisture:
(ii) a catalyst capable of catalyzing a reaction between molecular hydrogen and molecular oxygen:
(iii) a barrier means for restricting passage of organic molecules from a product contained, in use, in the container, to the catalyst.

3. A container according to claim 1, wherein the TPV per unit area (herein the “TPV-UA”) of a or said closure is less 0.00200 mg/cm² after 24 hours; and/or the TPV per unit area of said closure is less than 0.01000 mg/cm² after 72 hours, wherein:
$$TPV - UA = \frac{TPV in mg}{\begin{matrix}the surface area ( in {cm}^{2} ) of a catalyst - \\ containing layer of the closure which has the greatest surface area .\end{matrix}}$$

4. (canceled)

5. (canceled)

6. (canceled)

7. (canceled)

8. A closure according to claim 1, wherein said barrier material of said barrier means has a Hildebrand Solubility Parameter (HSP) of less than 15.2 MPa^{1/2}.

9. A closure according to claim 1, wherein said barrier means comprises a substantially continuous layer of barrier material, wherein said layer has a thickness of less than 1 mm.

10. A closure according to claim 1, wherein said barrier means comprises barrier material which surrounds individual particles of catalyst so that a mass of composite particles is defined.

11. A closure container according to claim 9, wherein said layer is in a lamina form and said layer has a main area which is defined by a surface of the layer which has the greatest area, wherein said main area has an area of at least 2 cm².

12. (canceled)

13. A closure according to claim 9, wherein said layer comprises a fluorinated polymer.

14. A closure according to claim 1, wherein said barrier means comprises a barrier material which surrounds individual particles of catalyst so that a mass of composite particles is defined, each of which composite particles comprises catalyst surrounded by said barrier material

15. A closure according to claim 9, wherein said barrier material and/or said layer comprises a fluorinated polymer or a silicone-based material.

16. A closure according to claim 1, wherein said catalyst is embedded in a microporous material.

17. A closure according to claim 16, wherein said porous material has a zeolithic structure.

18. (canceled)

19. A closure according to claim 1, wherein said barrier means comprises a barrier material which is associated with a polymeric material (XX), wherein said barrier material has a HSP of less than 16.0 MPa^{1/2}, and said polymeric material (XX) has a HSP which is higher than the HSP of the barrier material.

20. (canceled)

21. A closure container according to claim 19, wherein a combination comprising said barrier material and associated catalyst is dispersed within polymeric material (XX); or
the barrier means comprises a layer of said barrier material and said layer defines an enclosure around catalyst particles, wherein the combination of barrier material and catalyst is dispersed within polymeric material (XX); or
wherein porous material and associated catalyst is dispersed within polymeric material (XX); or
wherein barrier material overlies said polymeric material (XX).

22. A closure according to claim 19, wherein polymeric material (XX) is selected from HDPE, PP, LLDPE, LDPE, PS, PET, EVA, SEBS, Nylon, thermoplastic elastomers (TPEs) and olefinic block copolymers (OBCs).

23. A closure according to claim 16, wherein said barrier means comprises said microporous material in which said catalyst is embedded and said microporous material and associated catalyst are dispersed within a polymeric material (XX), wherein polymeric material (XX) is a polyolefin polymer.

24. (canceled)

25. (canceled)

26. (canceled)

27. A closure according to claim 1, wherein: said catalyst is selected to catalyse a reaction between molecular hydrogen and molecular oxygen, to produce water, wherein said catalyst selected from palladium and platinum;
said hydrogen generating means includes a matrix material with which said active material is associated, wherein the matrix includes 1-60 wt % of active material; wherein said active material comprises a metal and/or a hydride; and
wherein said closure includes a control means for controlling the passage of moisture to said active material arranged to generate molecular hydrogen, wherein at least part of said control means is provided in a first layer and a second layer comprises said hydrogen generating means.

28. (canceled)

29. (canceled)

30. A container according to claim 2, wherein a container body of said container includes walls defined by polyester and catalyst is dispersed within the polyester which comprises PET made using an antimony-based catalyst.

31. A closure for a container, the closure comprising:
(i) a hydrogen generating means comprising an active material arranged to generate molecular hydrogen on reaction with moisture;
(ii) a catalyst capable of catalyzing a reaction between molecular hydrogen and molecular oxygen;
(iii) a barrier means for restricting passage of organic molecules to the catalyst;
wherein, said closure includes a barrier means comprising:
(AA) a barrier material which has a Hildebrand Solubility Parameter (HSP) of less than 16.0 MPa^{1/2}; and/or
(BB) a barrier material which is a porous material, for example a which includes pores with free diameters of less than 2 nm; and/or
(CC) a barrier material which surrounds individual particles of catalyst so that a mass of composite particles is defined, wherein each of said composite particles comprises catalyst surrounded by said barrier material.

32. A container according to claim 2, said container including a container body which comprises:
(i) a catalyst capable of catalyzing a reaction between molecular hydrogen and molecular oxygen;
(ii) a barrier means for restricting passage of organic molecules from a product contained, in use, in the container, to the catalyst;
wherein said container body includes said barrier means comprising:
(AA) a barrier material which has a Hildebrand Solubility Parameter (HSP) of less than 16.0 MPal^{1/2}; and/or
(BB) a barrier material which is a microporous material; and/or
(CC) a barrier material which surrounds individual particles of catalyst so that a mass of composite particles is defined, wherein each of said composite particles comprises catalyst surrounded by said barrier material.

33. (canceled)

34. (canceled)

35. (canceled)
